(19) United States
(12) Patent Application Publication
(10) Pub. No.: US 2017/0093937 A1
(43) Pub. Date: Mar. 30, 2017

(54) Storage Medium Storing Program and Teleconference Method

(71) Applicant: Brother Kogyo Kabushiki Kaisha, Nagoya-shi (JP)

(72) Inventor: Kenji Oike, Nagoya-shi (JP)

(21) Appl. No.: 15/276,843

(22) Filed: Sep. 27, 2016

(30) Foreign Application Priority Data
Sep. 30, 2015 (JP) 2015-192487

(51) Int. Cl. H04L 29/06

(52) U.S. Cl. CPC H04L 65/403; H04L 65/1089; H04L 65/4015

(57) ABSTRACT

A program for a first terminal apparatus configured to participate in a teleconference causes, when executed, the first terminal apparatus to perform operations including: transmitting document data to a second terminal apparatus participating in the teleconference through a first communicator of the first terminal apparatus connected to the network, the document data corresponding to a document image to be shared with the second terminal apparatus in the teleconference; acquiring, through the first communicator, a completion notification indicating that the document data is acquired at transmission destination of the document data, the transmission destination including the second terminal apparatus; and, in response to acquiring the completion notification, transmitting a display instruction to the second terminal apparatus through the first communicator. The display instruction is an instruction to display the document image corresponding to the document data on a display of the second terminal apparatus.

### CROSS REFERENCE TO RELATED APPLICATIONS

This application claims priority from Japanese Patent Application No. 2015-192487 filed Sep. 30, 2015. The entire content of the priority application is incorporated herein by reference.

### TECHNICAL FIELD

This disclosure relates to a storage medium storing a program executable by a computer that controls a terminal apparatus configured to participate in a teleconference through a network. This disclosure also relates to a teleconference method.

### BACKGROUND

A technology relating to a teleconference through a network is proposed. For example, a data conference system is disclosed. In the data conference system, a transmission-side terminal apparatus and a reception-side terminal apparatus are connected through a network. In the data conference system, display screen data of the transmission-side terminal apparatus is shared by the reception-side terminal apparatus. In the data conference system, the transmission-side terminal apparatus transmits at least part of display screen data to the reception-side terminal apparatus. The reception-side terminal apparatus receives the display screen data, performs a drawing process on a display screen, and transmits a reception completion signal of the display screen data to the transmission-side terminal apparatus. In response to reception of the reception completion signal, the transmission-side terminal apparatus is notified about display screen state information of the reception-side terminal apparatus.

### SUMMARY

According to one aspect, this specification discloses a non-transitory computer-readable storage medium storing a program executable by a computer that controls a first terminal apparatus configured to participate in a teleconference through a network. The program causes, when executed, the first terminal apparatus to perform operations including: a first transmitting operation of transmitting document data to a second terminal apparatus participating in the teleconference through a first communicator of the first terminal apparatus connected to the network, the document data corresponding to a document image to be shared with the second terminal apparatus in the teleconference; a first acquiring operation of acquiring, through the first communicator, a completion notification indicating that the document data is acquired at transmission destination of the document data, the transmission destination including the second terminal apparatus; and a second transmitting operation of, in response to acquiring the completion notification, transmitting a display instruction to the second terminal apparatus through the first communicator, the display instruction being an instruction to display the document image corresponding to the document data on a display of the second terminal apparatus.

According to another aspect, this specification also discloses a non-transitory computer-readable storage medium storing a program executable by a computer that controls a second terminal apparatus configured to participate in a teleconference through a network. The program causes, when executed, the second terminal apparatus to perform operations including: a fourth acquiring operation of acquiring document data through a second communicator of the second terminal apparatus connected to the network, the document data corresponding to a document image to be shared with a first terminal apparatus in the teleconference, the document image being specified by the first terminal apparatus participating in the teleconference; a third transmitting operation of, in response to acquiring the document data, transmitting, through the second communicator, a completion notification indicating that the document data is acquired; a fifth acquiring operation of acquiring, through the second communicator, a display instruction instructing displaying of the document data; and a displaying operation of, in response to acquiring the display instruction, displaying a document image corresponding to the document data on a display of the second terminal apparatus.

According to still another aspect, this specification also discloses a teleconference method conducted by a teleconference system including a first terminal apparatus and a second terminal apparatus participating in a teleconference through a network. The method includes: transmitting document data through a first communicator of the first terminal apparatus connected to the network, the document data corresponding to a document image to be shared with the second terminal apparatus in the teleconference; acquiring the document data transmitted from the first terminal apparatus, through a second communicator of the second terminal apparatus connected to the network; determining whether acquisition of the document data by the second terminal apparatus is completed; transmitting, in response to determining that acquisition of the document data by the second terminal apparatus is completed, a display instruction to the second terminal apparatus, the display instruction being an instruction to display a document image corresponding to the document data; acquiring the display instruction through the second communicator; and displaying, in response to acquiring the display instruction, the document image corresponding to the document data on a display of the second terminal apparatus.

### BRIEF DESCRIPTION OF THE DRAWINGS

Embodiments in accordance with this disclosure will be described in detail with reference to the following figures wherein:

FIG. 1 is a diagram showing an example of a teleconference system;

FIG. 2 shows an example of a teleconference screen showing a state in which a completion notification screen is displayed;

FIG. 3 shows an example of operating screens of applications, wherein respective operating screens of three applications are displayed;

FIG. 4 shows a flowchart of an instruction receiving process;

FIGS. 5A to 5E show examples of a document database;

FIG. 6 shows a flowchart of a document transmitting process;

FIG. 7 shows another example of the teleconference screen showing a state in which a document specifying screen is displayed;

FIG. 8 shows a flowchart of a priority-document determining process;

FIG. 9 shows a flowchart of a completion-notification receiving process;

FIG. 10 shows a flowchart of a timer process;

FIG. 11 shows a flowchart of a receiving process; and

FIG. 12 shows another example of the teleconference screen, wherein the upper diagram shows a state in which waiting information is displayed and the lower diagram shows a state in which a document image is displayed.

### DETAILED DESCRIPTION

A teleconference is often conducted in a state where a particular document image is shared by a plurality of terminal apparatuses. In this case, for example, a first terminal apparatus participating in the teleconference transmits document data corresponding to a document image to a second terminal apparatus participating in the teleconference. The second terminal apparatus displays the document image. After displaying the document image, the second terminal apparatus transmits, to the first terminal apparatus, a notification indicating that the document data has been received by the second terminal apparatus. Thus, the first terminal apparatus is notified about that information. Here, it is presumed that, when the user of the first terminal apparatus starts a presentation by using the document image, the user of the second terminal apparatus may have already started reading information included in the document image displayed before the start of the presentation. In addition, for example, there is also a case in which the user of the second terminal apparatus performs a particular operation on the second terminal apparatus on which the document image is displayed. In these cases, there is a possibility that the user of the second terminal apparatus is paying attention to a part that is not intended by the user of the first terminal apparatus.

In view of the foregoing, an example of the object of this disclosure is to provide a storage medium storing a teleconference program and a teleconference method that enables starting a presentation by using a document image in a state where each user participating in a teleconference pays attention to the same position in a document image for the teleconference.

Some aspects of this disclosure will be described while referring to the accompanying drawings.

<Teleconference System>

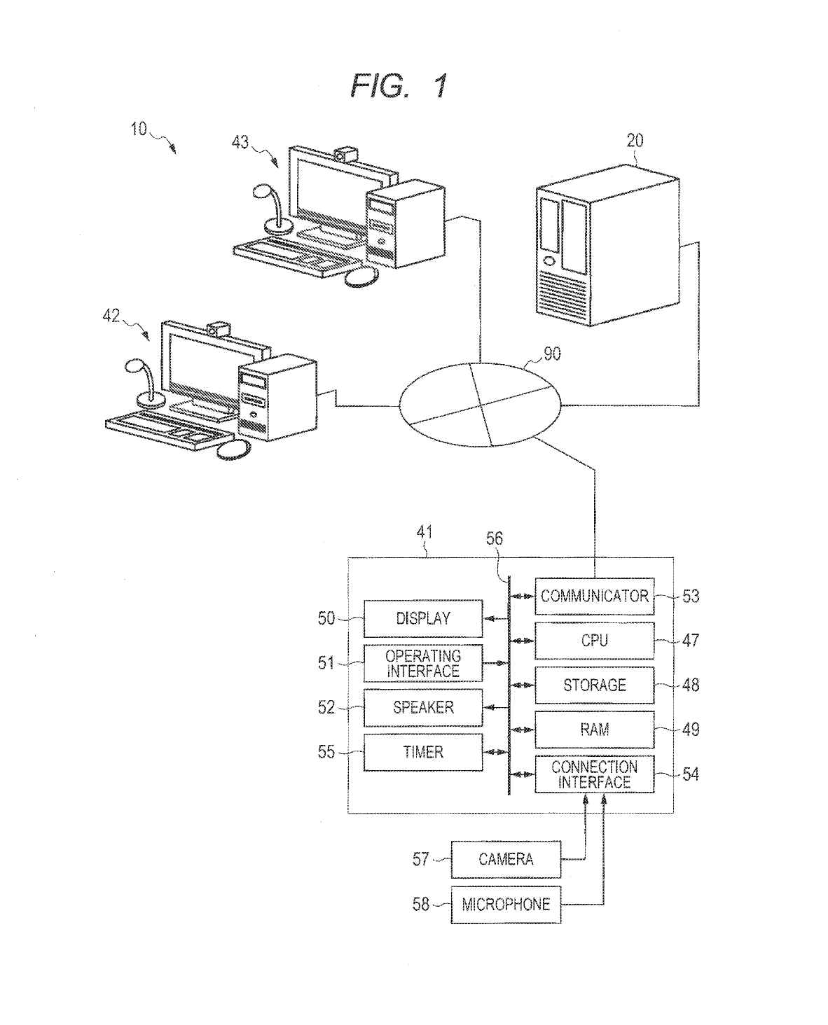

The overview of a teleconference system 10 will be described while referring to FIG. 1. As shown in FIG. 1, the teleconference system 10 includes a server apparatus 20 and a plurality of terminal apparatuses that participate in a teleconference. In FIG. 1, three terminal apparatuses are shown. The number of terminal apparatuses changes depending on the situation of a teleconference that is conducted. In the embodiment, a teleconference by three terminal apparatuses is described as an example.

The three terminal apparatuses shown in FIG. 1 are referred to as terminal apparatuses 41, 42, and 43, respectively. The terminal apparatuses 41, 42, and 43 are operated by three users attending the same teleconference.

The server apparatus 20 and the terminal apparatuses 41, 42, and 43 are connected to a network 90. For example, the network 90 is a network such as Internet and a local area network (LAN). In the teleconference system 10, a teleconference by the terminal apparatuses 41, 42, and 43 is performed in a state where a session is established between the server apparatus 20 and each of the terminal apparatuses 41, 42, and 43.

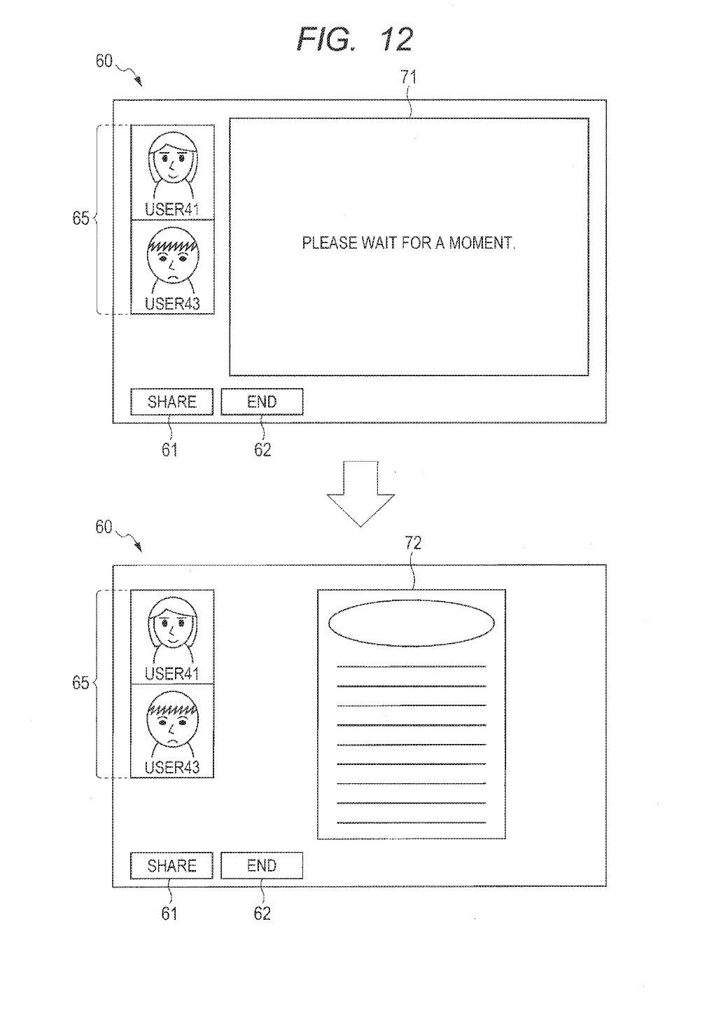

The server apparatus 20 relays various data and so on transmitted and received among the terminal apparatuses 41, 42, and 43. The data and so on transmitted and received among the terminal apparatuses 41, 42, and 43 include, for example, shot data shot by each of the terminal apparatuses 41, 42, and 43 and audio data collected by each of the terminal apparatuses 41, 42, and 43. Further, the server apparatus 20 transmits document data transmitted from one of the terminal apparatuses 41, 42, and 43 to the other two terminal apparatuses. The document data is image data corresponding to document image 72 (see FIGS. 3 and 12 described later) used in the teleconference. In the embodiment, for example, the document data is image data obtained by capturing an operating screen 70 of an application running in the terminal apparatus that is the transmission source of the document data. In the operating screen 70 that is the target of capturing, the document image 72 different by each application is displayed (see FIG. 3). In the teleconference system 10, in a similar manner to a known teleconference system, a teleconference can be conducted in a state where the document image 72 corresponding to document data is shared among the terminal apparatuses 41, 42, and 43. In addition, the server apparatus 20 relays a display instruction and a completion notification. The display instruction and the completion notification will be described later.

The teleconference conducted through the server apparatus 20 is identified by a conference ID. That is, the teleconference by the terminal apparatuses 41, 42, and 43 is differentiated, by the conference ID, from other teleconferences conducted through the server apparatus 20. In the teleconference identified by the conference ID, the terminal apparatuses 41, 42, and 43 are identified by terminal IDs. In the embodiment, each terminal ID of the terminal apparatuses 41, 42, and 43 is as follows. The terminal ID of the terminal apparatus 41 is “USER41”. The terminal ID of the terminal apparatus 42 is “USER42”. The terminal ID of the terminal apparatus 43 is “USER43”. Each data transmitted and received among the terminal apparatuses 41, 42, and 43 through the server apparatus 20 includes at least the conference ID and the terminal ID of the terminal apparatus that is the transmission source of transmitted data. The server apparatus 20 identifies terminal apparatuses participating in the same teleconference based on the conference ID, and transmits each data to the terminal apparatuses other than the transmission source.

The terminal apparatuses 41, 42, and 43 are personal computers, for example. Note that the terminal apparatuses 41, 42, and 43 may be a smartphone or a tablet device, for example. That is, the terminal apparatuses 41, 42, and 43 are the same or the same type of terminal apparatuses having a communication function through the network 90. Accordingly, the terminal apparatuses 41, 42, and 43 have similar configurations. The server apparatus 20 is a known server apparatus having a hardware configuration similar to a server apparatus in a known teleconference system. Thus, other descriptions for the server apparatus 20 are omitted.

<Terminal Apparatus>

The terminal apparatus 41 will be described while referring to FIGS. 1 to 3. As shown in FIG. 1, the terminal apparatus 41 includes a CPU 47, a storage 48, a RAM 49, a display 50, an operating interface 51, a speaker 52, a communicator 53, a connection interface 54, and a timer 55. The CPU 47, the storage 48, the RAM 49, the display 50, the operating interface 51, the speaker 52, the communicator 53, the connection interface 54, and the timer 55 are connected to a bus 56. In the embodiment, the connection interface 54 is abbreviated as “connection I/F 54”. A camera 57 and a microphone 58 are connected to the connection I/F 54. As described above, the terminal apparatuses 42, 43 are the same or the same type terminal apparatuses as the terminal apparatus 41. Accordingly, the terminal apparatuses 42, 43 have the same configuration as the terminal apparatus 41. The descriptions for the terminal apparatuses 42, 43 are omitted.

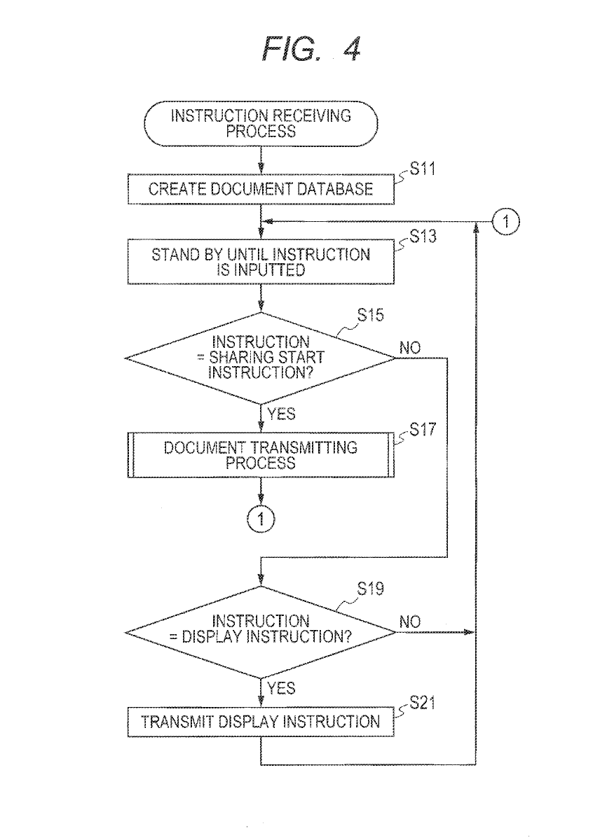

The CPU 47 executes arithmetic processes. The storage 48 includes a computer-readable storage medium. For example, the storage 48 includes a hard disk and/or flash memory. Also, the storage 48 may include a ROM. The storage 48 stores various programs. For example, the storage 48 stores an OS and various applications. The applications stored in the storage 48 include programs for teleconferences conducted by the teleconference system 10. The programs for teleconferences include programs of each process executed by the terminal apparatus 41 described later (see FIGS. 4, 6, and 8 to 11). The OS stored in the storage 48 is a known OS. The OS manages applications running in the terminal apparatus 41, and further manages an application in an active state out of the running applications.

These programs of each process may be preliminarily installed in the storage 48. Alternatively, these programs may be transmitted to the terminal apparatus 41 as transmission signals through the network 90 from the server apparatus 20 when the terminal apparatus 41 accesses the server apparatus 20 for connecting to a teleconference, and may be installed in the storage 48 at that timing. In this case, the program may be stored in the RAM 49. For example, the preliminary install is performed by reading a program stored in a computer-readable storage medium such as a semiconductor memory by a reader (not shown) of the terminal apparatus 41. If the terminal apparatus 41 includes an optical drive (not shown), for example, the preliminary install may be performed by reading the program stored in an optical medium by the optical drive. Also, the preliminary install may be performed by receiving the program stored in a computer-readable storage medium such as a hard disk of a server apparatus (the server apparatus 20 or a server apparatus not shown in the drawings) connected to the terminal apparatus 41 through the network 90, as transmission signals, by the communicator 53. Which method is adopted is determined appropriately by considering various conditions. The computer-readable storage medium may be a non-transitory storage medium that does not include a transitory storage medium (for example, transmission signals). It is sufficient that a non-transitory storage medium store information, irrespective of a time period of storing the information.

The RAM 49 is a memory area that is used when the CPU 47 executes various programs. For example, the RAM 49 stores particular data that are used by a process when the process is executed. In the terminal apparatus 41, the CPU 47 appropriately executes the OS stored in the storage 48 and the programs of each process shown in FIGS. 4, 6, and 8 to 11, thereby controlling the terminal apparatus 41. With this operation, the terminal apparatus 41 executes various processes.

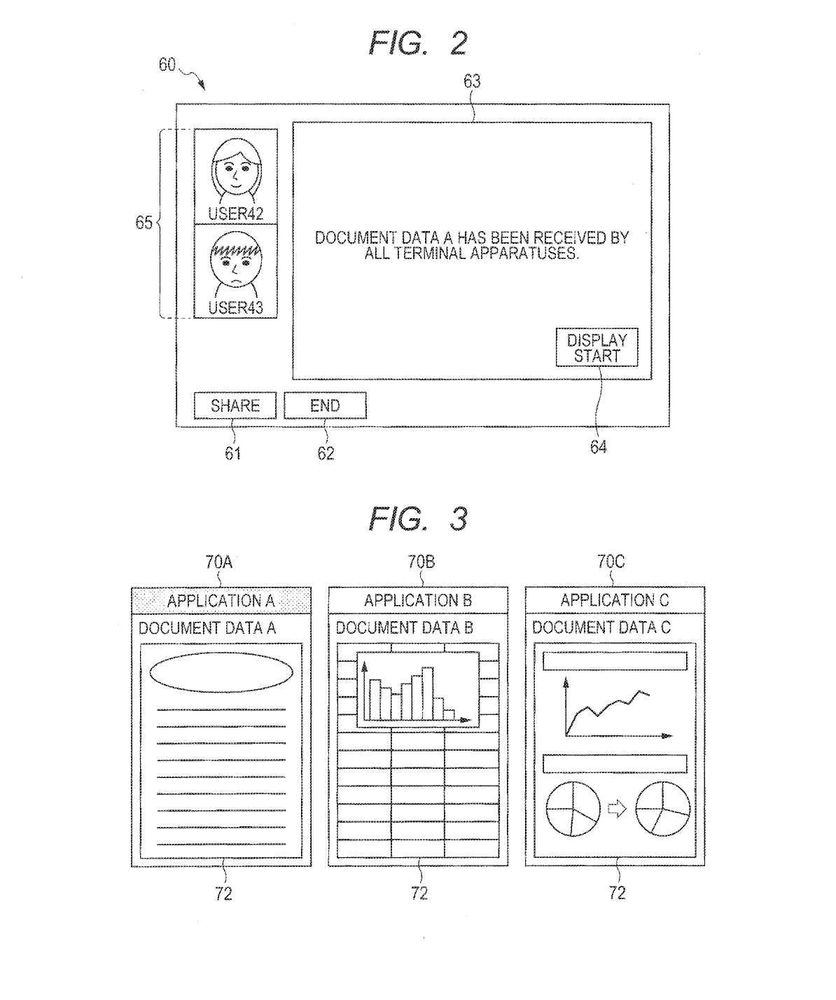

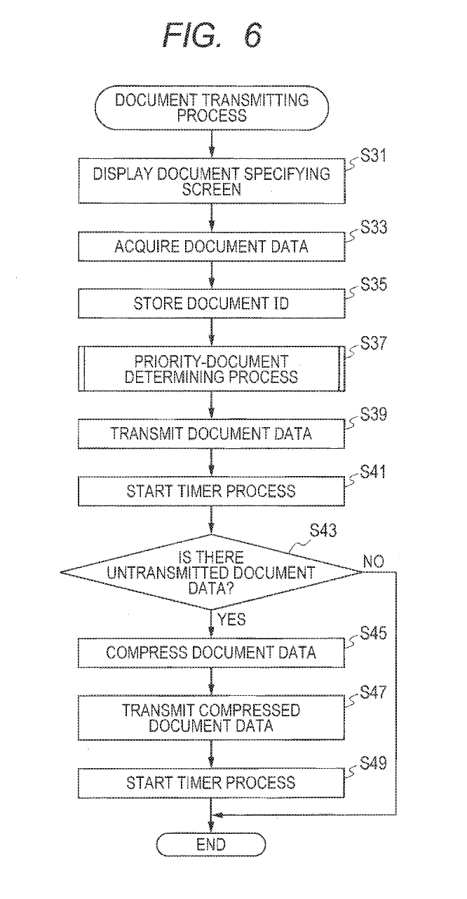

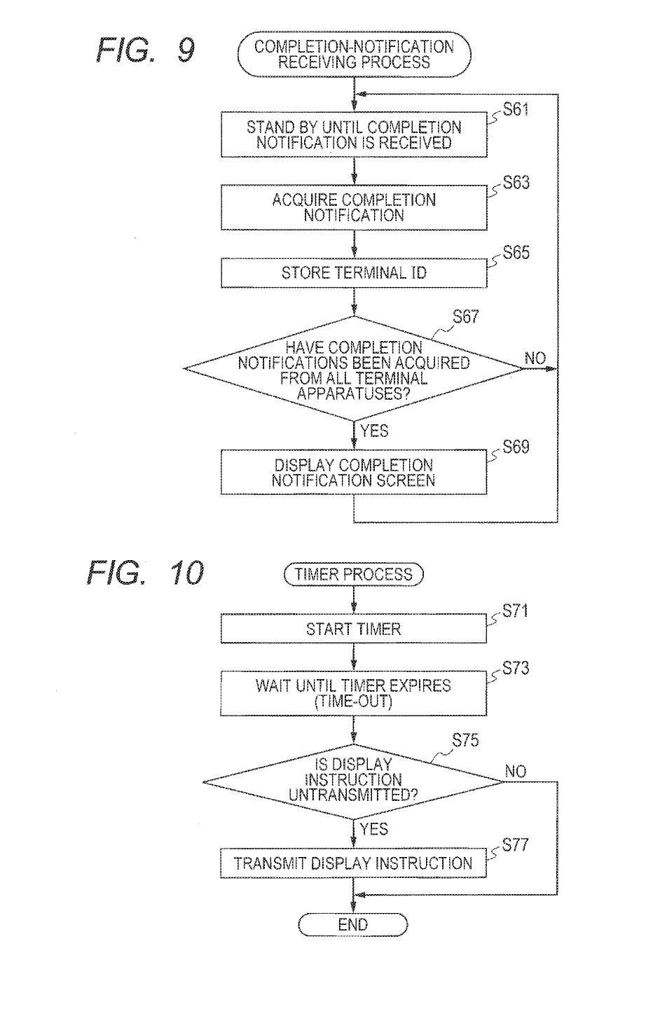

The display 50 is a liquid crystal display, for example. The display 50 displays various kinds of information. The display 50 displays a teleconference screen 60. The teleconference screen 60 is an operating screen provided by a program for teleconference. As shown in FIG. 2, the teleconference screen 60 includes a share button 61 and an end button 62. On the teleconference screen 60, a completion notification screen 63 and a shot image 65 are displayed. The teleconference screen 60 shown in FIG. 2 is an example of a teleconference screen that is displayed on the display 50 of the terminal apparatus 41 while a teleconference by the terminal apparatuses 41, 42, and 43 is conducted (see S69 of FIG. 9 described later). The share button 61 is associated with a sharing start instruction. The sharing start instruction is an instruction for starting a document transmitting process shown in FIG. 6. The end button 62 is associated with an end of the teleconference. When the user of the terminal apparatus 41 ends the teleconference, the user operates the operating interface 51 to press the end button 62. In this case, the teleconference ends, and the session established with the server apparatus 20 is disconnected.

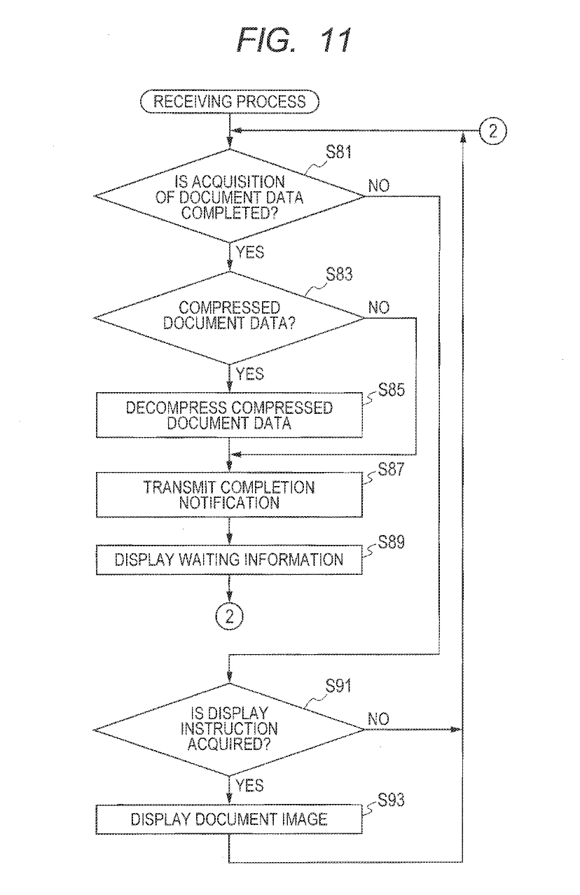

The completion notification screen 63 includes a display start button 64. The other descriptions for the completion notification screen 63 will be provided later. The display start button 64 is associated with a display instruction. For example, the display instruction is an instruction for starting display of the document image 72 corresponding to received document data at the terminal apparatuses 42, 43 having received document data from the terminal apparatus 41 that is the transmission source of the document data. The display instruction includes a document ID. The document ID is information identifying document data. A plurality of document data is identified by a document ID unique to each document data. In the terminal apparatuses 42, 43, when the display instruction is received, document data is identified by the document ID included in the display instruction, and the document image 72 corresponding to the identified document data is displayed on the teleconference screen 60 (see FIGS. 11 and 12 described later).

For example, the shot image 65 is an image corresponding to video data sent from the terminal apparatuses 42, 43. On the teleconference screen 60, the shot image 65 corresponding to video data shot by the user's own terminal apparatus can be displayed. On the teleconference screen 60, display or non-display of the shot image 65 can be set. The display or non-display of the shot image 65 can be set individually to each of the shot image 65. On the teleconference screen 60 shown in FIG. 2, the shot image 65 of the terminal apparatus 41 having the terminal ID “USER41” is set to non-display, and the shot images 65 of the terminal apparatuses 42, 43 having the terminal IDs “USER42” and “USER43” are set to display. On the teleconference screen 60, the two shot images 65 are displayed in accordance with display settings of the shot image 65 of the terminal apparatuses 42, 43.

In the display 50, out of the applications stored in the storage 48, the operating screen 70 of running applications is displayed. For example, it is assumed that the application running in the terminal apparatus 41 is three applications A, B, and C. In this case, the operating screen 70 of each of the applications A, B, and C is displayed. As shown in FIG. 3, the plurality of operating screens 70 is displayed at the same time. In FIG. 3, the hatching around the texts “Application A” indicates that the application A is in an active state out of the applications A, B, and C. For example, the application of the operating screen 70 selected to currently receive an input (the operating screen having focus, for example) is in an active state. In the embodiment, when the applications running in the terminal apparatus 41 are differentiated from one another, the applications A, B, and C are used as an example. The operating screen 70 of the application A is referred to as “operating screen 70A”. The operating screen 70 of the application B is referred to as “operating screen 70B”. The operating screen 70 of the application C is referred to as “operating screen 70C”. When the operating screens 70A, 70B, and 70C are not differentiated or collectively referred to, those are referred to as “operating screen 70”.

The operating interface 51 receives inputs such as various instructions to the terminal apparatus 41. The operating interface 51 includes a keyboard and a mouse. Details are omitted, but a process that generates operational information corresponding to each operation to the keyboard and mouse is technology used in known personal computers. The terminal apparatus 41 also adopts this technology. The speaker 52 is an example of a sound output device that outputs sound. For example, sound outputted by the speaker 52 is sound corresponding to audio data transmitted from the terminal apparatuses 42, 43 described above. The communicator 53 connects the terminal apparatus 41 to the network 90, and performs data communication through the network 90. In the terminal apparatus 41, various data are transmitted to and received from the server apparatus 20 through the communicator 53. The communicator 53 is an interface circuit that is adapted to the ETHERNET™ standard, for example. Connection to the network 90 by the communicator 53 may be wireless connection or hard-wired connection.

The connection I/F 54 is an interface for connecting a particular device to the terminal apparatus 41. For example, the connection I/F 54 is an interface having a USB (Universal Serial Bus) port. The connection I/F 54 may include a wireless communication module. An example of the wireless communication module includes a communication module adapted to Bluetooth™. The camera 57 connected to the connection I/F 54 captures an external image. The terminal apparatus 41 may have a built-in camera. The microphone 58 connected to the connection I/F 54 is an example of a sound collector that collects external sound. For example, the microphone 58 collects voices outputted by a user who operates the terminal apparatus 41.

The timer 55 measures time. The timer 55 may use a clock function included in the OS. The terminal apparatus 41 is different from a known terminal apparatus having a communication function, in that the storage 48 or the RAM 49 stores programs of each process described later (see FIGS. 4, 6, and 8 to 11). However, in terms of hardware, the terminal apparatus 41 is the same as a known terminal apparatus.

<Process Executed by Terminal Apparatus>

Each process executed by the terminal apparatus 41 when a teleconference is conducted by the terminal apparatuses 41, 42, and 43 will be described. In the terminal apparatus 41, an operation for the URL of the server apparatus 20 is inputted through the operating interface 51. When this operation is inputted, the CPU 47 starts up the program for teleconference. In response to startup of this program, the terminal apparatus 41 accesses the server apparatus 20 and establishes a session with the server apparatus 20. The procedure executed by the terminal apparatus 41 when establishing a session with the server apparatus 20 is the same as the procedure in a known teleconference system. Accordingly, descriptions for the procedure are omitted.

When a session is established with the server apparatus 20, the terminal apparatus 41 becomes a state in which the terminal apparatus 41 has participated in the teleconference identified by the conference ID. That is, the user of the terminal apparatus 41 becomes a state in which the user has entered a virtual conference room in which the teleconference identified by the conference ID is conducted. When the session is established with the server apparatus 20, the terminal apparatus 41 transmits video data shot by the camera 57 and audio data corresponding to sound collected by the microphone 58, through the communicator 53, to the server apparatus 20. The server apparatus 20 transmits video data and audio data sent from the terminal apparatus 41 to the terminal apparatus 42, 43 for which the session is established. The server apparatus 20 transmits, to the terminal apparatus 41, video data and audio data sent from the terminal apparatus 42, 43 for which the session is established. When the session is established with the server apparatus 20, the terminal apparatus 41 displays the teleconference screen 60 on the display 50. The terminal apparatus 41 receives, at the communicator 53, video data and audio data transmitted, through the server apparatus 20, from one or both of the terminal apparatuses 42, 43 for which the session is established. On the teleconference screen 60 displayed on the display 50, the shot image 65 corresponding to the received video data is displayed. The speaker 52 outputs sound corresponding to the received audio data. In the terminal apparatus 42, 43, too, when video data and audio data are received from the terminal apparatus 41, the teleconference screen 60 including the shot image 65 corresponding to the video data is displayed, and sound corresponding to the audio data is outputted. In the embodiment, descriptions for each of these processes are omitted.

In order to end the teleconference, in the terminal apparatus 41, the operating interface 51 is operated to press the end button 62 displayed on the teleconference screen 60. In this case, the terminal apparatus 41 performs procedures for disconnecting the session with the server apparatus 20. Due to disconnection of the session, the teleconference at the terminal apparatus 41 ends. The procedures performed by the terminal apparatus 41 for disconnecting the session with the server apparatus 20 are similar to procedures in a known teleconference system. Accordingly, descriptions for each of these procedures are omitted.

In the terminal apparatuses 42, 43, too, the processes similar to those of the terminal apparatus 41 are executed. In the following description, it is assumed that a session is established between the server apparatus 20 and the terminal apparatus 42, 43. In the teleconference identified by the conference ID, the server apparatus 20 transmits, to the terminal apparatuses 41, 42, and 43, a connection list including each terminal ID of the terminal apparatuses 41, 42, and 43 for which the session is established. The terminal apparatuses 41, 42, and 43 store the connection list and, in accordance with the connection list, identify other terminal apparatuses for which the session is established with the server apparatus 20, and execute various processes such as determinations. In the terminal apparatus 41, the connection list is stored in the RAM 49. In the terminal apparatuses 42, 43, too, the connection list is stored in the RAM.

<Instruction Receiving Process>

An instruction receiving process will be described while referring to FIG. 4.

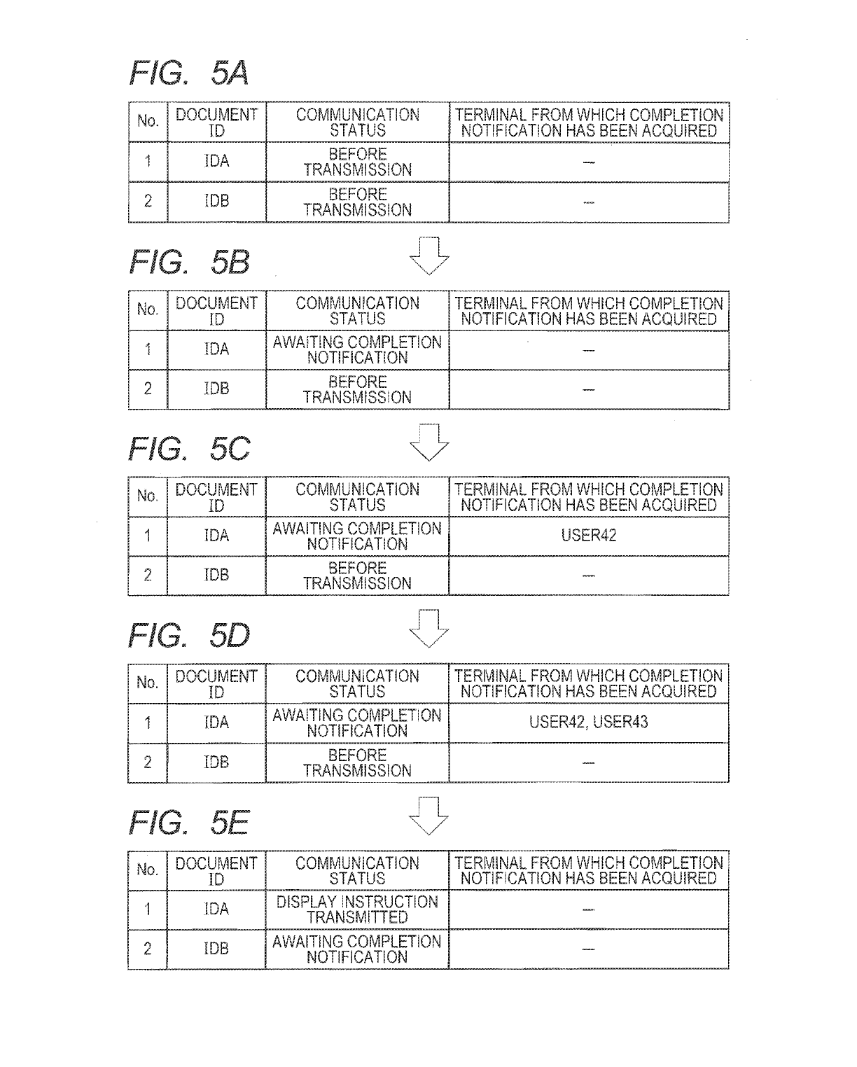

The instruction receiving process is started at timing when the session is established with the server apparatus 20. The CPU 47 having started the instruction receiving process creates a document database (S11). The created document database is stored in the RAM 49. As shown in FIGS. 5A to 5E, the document database stores a document ID, a communication status, and a “terminal from which completion notification has been acquired”, in association with one another. The communication status is a status indicative of a communication status of the process for the document data identified by the document ID. The communication status stores one of “before transmission”, “awaiting completion notification”, and “display instruction transmitted”. The communication status “before transmission” indicates that document data has not been transmitted to the terminal apparatus 42, 43. The communication status “awaiting completion notification” indicates that a completion notification has not been acquired from both of the terminal apparatuses 42, 43. The communication status “display instruction transmitted” indicates that a display instruction has been transmitted to both of the terminal apparatuses 42, 43. When the communication status is “awaiting completion notification”, the “terminal from which completion notification has been acquired” stores the terminal ID of the terminal apparatus that is the transmission source of a completion notification (see S65 of FIG. 9 described later). The item “No.” is provided in the document database shown in FIGS. 5A to 5E, but this is for description purposes and may be omitted.

After executing S11, the CPU 47 stands by until the operating interface 51 is operated to input a particular instruction (S13). In response to input of the particular instruction, the CPU 47 acquires the instruction inputted through the operating interface 51. In response to acquisition of the particular instruction, the CPU 47 determines whether the acquired instruction is a sharing start instruction (S15). The user operates the operating interface 51 to press the share button 61 displayed on the teleconference screen 60. In response to press of the share button 61, the CPU 47 acquires the sharing start instruction.

When the acquired instruction is a sharing start instruction (S15: Yes), the CPU 47 executes a document transmitting process (S17). The document transmitting process will be described later. After executing S17, the CPU 47 returns the process to S13. After that, the CPU 47 repeatedly executes the processes in S13 and thereafter. When the acquired instruction is not a sharing start instruction (S15: No), the CPU 47 determines whether the acquired instruction is a display instruction (S19). The user operates the operating interface 51 to press the display start button 64 in the completion notification screen 63 displayed on the teleconference screen 60. In response to press of the display start button 64, the CPU 47 acquires a display instruction. The completion notification screen 63 is displayed in S69 of FIG. 9 described later.

When the acquired instruction is a display instruction (S19: Yes), the CPU 47 transmits a display instruction (S21). The display instruction includes a document ID as described above. The document ID included in the display instruction is the document ID included in image data corresponding to the completion notification screen 63 that is being displayed. The setting of the document ID to the image data corresponding to the completion notification screen 63 will be described later. The CPU 47 outputs a transmission command of the display instruction to the communicator 53. In accordance with the transmission command, the display instruction is transmitted from the communicator 53 to the server apparatus 20. Further, the display instruction is transmitted from the server apparatus 20 to the terminal apparatuses 42, 43. After transmitting the display instruction, the CPU 47 accesses the document database, and updates the communication status associated with the document ID included in the display instruction to “display instruction transmitted” (see “No. 1” record of FIG. 5E).

When the acquired instruction is not a display instruction (S19: No) or after executing S21, the CPU 47 returns the process to S13. After that, the CPU 47 repeatedly executes the processes in S13 and thereafter. The instruction receiving process is continued until an end instruction is acquired due to press of the end button 62.

<Document Transmitting Process>

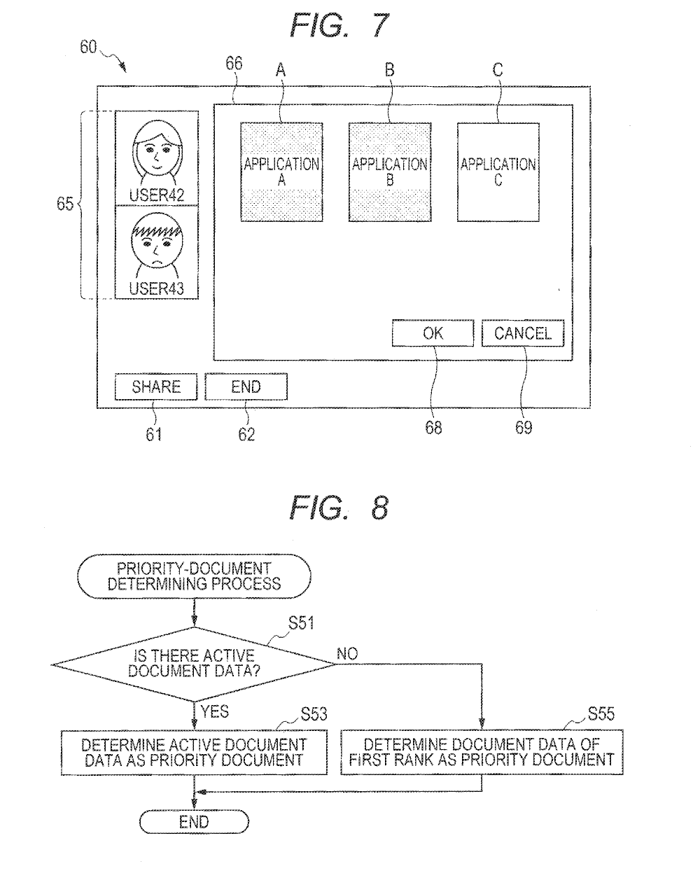

A document transmitting process executed in S17 of FIG. 4 will be described while referring to FIG. 6. The CPU 47 having started the document transmitting process displays a document specifying screen 66 (S31). The CPU 47 outputs, to the display 50, an output command for displaying the document specifying screen 66 on the teleconference screen 60. On the display 50, in accordance with the output command, the document specifying screen 66 is displayed on the teleconference screen 60. As shown in FIG. 7, the document specifying screen 66 includes an OK button 68, a cancel button 69, and icon images. The OK button 68 is associated with a share instruction that specifies document data. The cancel button 69 is associated with a cancel instruction that specifies document data. In response to press of the cancel button 69, the document transmitting process ends. The icon image is an image corresponding to each application that is running on the terminal apparatus 41 (see FIG. 3). The CPU 47 acquires, from the OS, information on applications running on the terminal apparatus 41. When S31 is executed, a teleconference program is also running on the terminal apparatus 41. However, an icon image corresponding to the teleconference program is excluded from the document specifying screen 66.

For example, assume that the applications running on the terminal apparatus 41 are three applications A, B, and C (see FIG. 3). In this case, the document specifying screen 66 includes an icon image A of the application A, an icon image B of the application B, and an icon image C of the application C. In the embodiment, when document data are differentiated from one another, document data obtained by capturing the operating screen 70A of the application A is referred to as “document data A”, document data obtained by capturing the operating screen 70B of the application B is referred to as “document data B”, and document data obtained by capturing the operating screen 70C of the application C is referred to as “document data C”. When document IDs are differentiated from one another, the document ID of the document data A is referred to as “IDA”, the document ID of the document data B is referred to as “IDB”, and the document ID of the document data C is referred to as “IDC”.

The user operates the operating interface 51 to select at least one of the icon images A, B, C. The hatching (shade) on the icon images A, B in FIG. 7 indicates that the icon images A, B are in a selected state. For example, when the icon image A is pressed and then the icon image B is pressed, the document specifying screen 66 becomes a state shown in FIG. 7. When the OK button 68 is pressed in the state shown in FIG. 7, the applications A, B are specified as the target to share. In this case, the CPU 47 acquires a share instruction that specifies the applications A, B. In response to press of a plurality of icon images, the CPU 47 stores the pressing order (the order of press of the plurality of icon images) in the RAM 49. For example, based on the above-described example, the CPU 47 stores the document ID “IDA” applied to the document data A obtained from the application A as the first rank in the pressing order, and stores the document ID “IDB” applied to the document data B obtained from the application B as the second rank in the pressing order. In the embodiment, the document data of the document ID of the first rank in the pressing order is referred to as “first rank document data”.

Next, the CPU 47 acquires document data (S33). Subsequently, the CPU 47 accesses the document database, and stores the document ID of the acquired document data (S35). Assume that the share instruction specifies the applications A, B. In S33, the CPU 47 captures the operating screen 70A including a particular document image 72 to acquire document data A. The document data A includes the document ID “IDA”. The CPU 47 captures the operating screen 70B including another document image 72 to acquire document data B. The document data B includes the document ID “IDB”. For capturing the operating screen 70, a known capturing technology is used. The teleconference program includes a program for a capturing process using the known capturing technology. However, the program for the capturing process may be a separate program from the teleconference program. Capturing of the operating screen 70 is performed by executing this program. The other descriptions relating to capturing of the operating screen 70 are omitted. The acquired document data is stored in the RAM 49. In S35, the CPU 47 stores the document IDs “IDA” and “IDB” in the document database (see FIG. 5A). The CPU 47 stores the communication status “before transmission” in association with the document IDs “IDA” and “IDB”. No terminal is stored as the “terminal from which completion notification has been acquired”. Subsequently, the CPU 47 executes a priority-document determining process (S37). The priority-document determining process will be described later.

After executing S37, the CPU 47 transmits document data (S39). The document data of the transmission target is one document data determined by the priority-document determining process (see S53 or S55 in FIG. 8). The CPU 47 outputs a transmission command of the document data to the communicator 53. In accordance with the transmission command, the document data is transmitted from the communicator 53 to the server apparatus 20. Further, the document data is transmitted from the server apparatus 20 to the terminal apparatuses 42, 43. After transmitting the document data, the CPU 47 accesses the document database, and updates the communication status associated with the document ID of the transmitted document data to “awaiting completion notification” (see “No. 1” record in FIG. 5B). Subsequently, the CPU 47 starts a timer process (S41). In the timer process started in S41, the timer 55 measures an elapse time that has elapsed after transmission of the document data in S39. Accordingly, the timer process started in S41 is managed in association with the document ID of the document data transmitted in S39. The timer process will be described later.

After executing S41, the CPU 47 determines whether there is untransmitted document data in the document data acquired in S33 (S43). When there is untransmitted document data, the CPU 47 makes positive determination in S43 (S43: Yes), and moves the process to S45. When there is no untransmitted document data, the CPU 47 makes negative determination in S43 (S43: No), and ends the document transmitting process. For example, assume that the document data A, B or the document data A, B, C are acquired in S33 and that the document data A is transmitted in S39. In this case, the document data B or the document data B, C exists as untransmitted document data. Thus, the CPU 47 makes positive determination in S43 (S43: Yes). On the other hand, assume that the document data A is acquired in S33, and the document data A is transmitted in S39. In this case, there is no untransmitted document data. Thus, the CPU 47 makes negative determination in S43 (S43: No).

In S45, the CPU 47 compresses untransmitted document data. When there is a plurality of untransmitted document data, the plurality of document data is put together into one compression file. For compression of document data, a known compression technology (for example, a lossless compression format such as ZIP or RAR) is used. Although descriptions are omitted in the above, the storage 48 stores a program for compression and decompression processing using a known compression technology. In S45, this program is executed. This program may be included in the OS. The other descriptions relating to compression of document data are omitted. Subsequently, the CPU 47 transmits the compressed document data (S47). The CPU 47 outputs a transmission command of the compressed document data to the communicator 53. In accordance with the transmission command, the compressed document data is transmitted from the communicator 53 to the server apparatus 20. Further, the compressed document data is transmitted from the server apparatus 20 to the terminal apparatuses 42, 43. After transmitting the document data, the CPU 47 accesses the document database, and updates the communication status associated with the document ID of the document data transmitted in a compressed state to “awaiting completion notification” (see FIG. 5E).

Subsequently, the CPU 47 starts a timer process (S49). In the timer process started in S49, the timer 55 measures the elapse time after transmission of the document data compressed in S45. Accordingly, the timer process started in S49 is managed in association with the document ID of the document data transmitted in a compressed state in S47. If a plurality of document data is transmitted in a state in which the plurality of document data is put together in one compression file, the timer process started in S49 is managed in association with each document ID of the plurality of document data transmitted in S47. The timer process will be described later. After that, the CPU 47 ends the document transmitting process.

As described above, document data is an image data obtained by capturing the operating screen 70 including the document image 72. Capturing of each operating screen 70 started in S33 is performed continuously. Accordingly, the CPU 47 repeatedly acquires document data obtained by capturing each operating screen 70 at a particular interval, for example, and repeats transmission of the acquired document data. For example, the CPU 47 may repeat the steps S33 to S39 and S43 to S47 in FIG. 6.

<Priority-Document Determining Process>

The priority-document determining process executed in S37 of FIG. 6 will be described while referring to FIG. 8. The CPU 47 having started the priority-document determining process determines whether there is active document data in the document data acquired in S33 of FIG. 6 (S51). The active document data is document data corresponding to the document image 72 in the operating screen 70 of the application that is currently in an active state in the terminal apparatus 41. In S51, the CPU 47 acquires, from the OS, information on the application in an active state. Subsequently, the CPU 47 determines whether active document data is included in the document data acquired in S33 of FIG. 6.

When there is active document data in the document data acquired in S33 of FIG. 6 (S51: Yes), the CPU 47 identifies active document data from among the document data acquired in S33 of FIG. 6 (S53). When there is no active document data in the document data acquired in S33 of FIG. 6 (S51: No), the CPU 47 identifies document data of the first rank from among the document data acquired in S33 of FIG. 6 in accordance with the pressing order stored in the RAM 49 (S55). The CPU 47 stores, in the RAM 49, the document ID of the document data identified in S53 or S55. After executing S53 or S55, the CPU 47 ends the priority-document determining process.

<Completion Notification Receiving Process>

The completion notification receiving process will be described while referring to FIG. 9. Similar to the instruction receiving process described above, the completion notification receiving process is started at timing when the session is established with the server apparatus 20. Alternatively, the completion notification receiving process may be started at timing when S39 of FIG. 6 is executed, for example. The CPU 47 having started the completion notification receiving process stands by until a completion notification is received at the communicator 53 (S61). The completion notification is a notification indicating that document data transmitted in S39 of FIG. 6 or compressed document data transmitted in S47 of FIG. 6 has been acquired by the terminal apparatus of the transmission destination. The completion notification includes the document ID and the terminal ID of the terminal apparatus of the transmission source of the completion notification. The document ID included in the completion notification is the document ID included in the document data acquired in the terminal apparatus. When the completion notification is received at the communicator 53, the CPU 47 acquires the completion notification through the communicator 53 (S63).

The CPU 47 identifies the document ID and the terminal ID included in the acquired completion notification. Subsequently, the CPU 47 accesses the document database, and stores the identified terminal ID (S65). The terminal ID is stored as the “terminal from which completion notification has been acquired”, in association with the identified document ID. For example, assume that the document ID and the terminal ID included in the acquired completion notification are “IDA” and “USER42”, respectively. At this time, it is also assumed that a completion notification including the document ID “IDA” is not acquired from the terminal apparatus 43. In this case, in the document database, “USER42” is stored as the “terminal from which completion notification has been acquired”, in association with the document ID “IDA” and the communication status “awaiting completion notification” (see the “No. 1” record in FIG. 5C). When the completion notification includes a plurality of document IDs, the one terminal ID included in the completion notification is stored as the “terminal from which completion notification has been acquired”, in association with each document ID.

Next, for the document data of the document ID included in the completion notification acquired in S63, the CPU 47 determines whether the completion notifications have been acquired from all the terminal apparatuses 42, 43 that are counterparts of the teleconference (S67). At that time, the CPU 47 identifies the terminal IDs “USER42” and “USER43” of the terminal apparatuses 42, 43 for which a session is established with the server apparatus 20, from the connection list stored in the RAM 49. Assume that the storage state of the document database after executing S65 is the state of the “No. 1” record in FIG. 5C. In this “No. 1” record, the terminal ID “USER42” is stored as the “terminal from which completion notification has been acquired”, but the terminal ID “USER43” is not stored yet. That is, the completion notification including the document ID “IDA” has not been acquired from the terminal apparatus 43. Accordingly, the CPU 47 makes negative determination in S67 (S67: No). In this case, the CPU 47 returns the process to S61. After that, the CPU 47 repeatedly executes the processes in S61 and thereafter. Assume that the storage state of the document database after executing S65 is the state of the “No. 1” record in FIG. 5D. In this “No. 1” record, the terminal IDs “USER42” and “USER43” are stored as the “terminal from which completion notification has been acquired”. That is, the completion notifications including the document ID “IDA” have been acquired from the terminal apparatuses 42, 43. Accordingly, the CPU 47 makes positive determination in S67 (S67: Yes). In this case, the CPU 47 moves the process to S69.

In S69, the CPU 47 displays the completion notification screen 63. The CPU 47 outputs, to the display 50, an output command for displaying the completion notification screen 63 on the teleconference screen 60. On the display 50, the completion notification screen 63 is displayed on the teleconference screen 60 in accordance with the output command. For example, assume that the storage state of the document database after executing S65 is the state of the “No. 1” record in FIG. 5D and, as a result, positive determination is made in S67 (S67: Yes). In this case, the CPU 47 generates image data corresponding to the completion notification screen 63. This image data includes the document ID “IDA” and completion information. The completion information in this case is information indicating that the completion notifications from the terminal apparatuses 42, 43 including the document ID “IDA” have been acquired. In the embodiment, the completion information is “Document data A has been received by all the terminal apparatuses” (see FIG. 2). After executing S69, the CPU 47 returns the process to S61. After that, the CPU 47 repeatedly executes the processes in S61 and thereafter.

<Timer Process>

The timer process started in S41 or S49 of FIG. 6 will be described while referring to FIG. 10. When S41 and S49 in FIG. 6 are executed and a plurality of document data are transmitted, the number of the timer processes corresponding to the number of the transmitted document data is executed in parallel. The CPU 47 having started the timer process starts the timer 55 (S71). The timer 55 starts measurement of the elapse time. After that, the CPU 47 waits until the time measured by the timer 55 expires (time-out) (S73). The time until time-out is appropriately set in consideration of various conditions. For example, the time before time-out is three minutes.

When the time measured by the timer 55 becomes time-out, the CPU 47 determines whether the display instruction including the document ID associated with the timer process is untransmitted (S75). The CPU 47 accesses the document database, and identifies the communication status associated with the document ID of the timer process. When the identified communication status is that the display instruction has been transmitted, the CPU 47 makes negative determination in S75 (S75: No). In this case, the CPU 47 ends the timer process. When the identified communication status is that the display instruction has not been transmitted, the CPU 47 makes positive determination in S75 (S75: Yes). In this case, the CPU 47 moves the process to S77.

In S77, the CPU 47 transmits the display instruction. The display instruction includes the document ID of the timer process. Further, the display instruction includes the terminal ID of the terminal apparatus that is the transmission destination. The terminal apparatus of the transmission destination is the terminal apparatus of the terminal ID stored as the “terminal from which completion notification has been acquired”, in the document database, in association with the document ID of the timer process. Based on the “No. 1” record in FIG. 5C, the transmission destination of the display instruction is the terminal apparatus 42 of the terminal ID “USER42”. The server apparatus 20 determines, as the transfer destination of the display instruction, the terminal apparatus of the terminal ID included in the display instruction as the transmission destination. After executing S77, the CPU 47 ends the timer process. If another timer process is executed in parallel, the other timer process is continued.

<Receiving Process>

The receiving process will be described while referring to FIG. 11. The receiving process is executed by the terminal apparatus that is the transmission destination of document data. In the above description, the terminal apparatus 41 is the terminal apparatus of the transmission source of document data, and the terminal apparatuses 42, 43 are the terminal apparatuses of the transmission destination of document data. In a teleconference conducted by the terminal apparatuses 41, 42, and 43, there are cases in which one of the terminal apparatuses 42, 43 becomes the terminal apparatus of the transmission source of document data, and each process shown in FIGS. 4, 6 and 8 to 10 described above is executed by one of the terminal apparatuses 42, 43. In this case, the terminal apparatus 41 becomes the terminal apparatus of the transmission destination of document data, and the receiving process is executed by the terminal apparatus 41. The embodiment will be described assuming that the terminal apparatus 41 executes the receiving process.

Similar to the instruction receiving process shown in FIG. 4, the receiving process is started at the timing when a session is established with the server apparatus 20. The CPU 47 having started the receiving process determines whether acquisition of document data is completed (S81). The document data is transmitted in S39 or S47 of FIG. 6, and is received at the communicator 53. The CPU 47 acquires the document data through the communicator 53. The document data is stored in the RAM 49. When acquisition of the document data is not completed (S81: No), the CPU 47 moves the process to S91. When acquisition of the document data is completed (S81: Yes), the CPU 47 determines whether the acquired document data is compressed document data (S83). The compressed document data is transmitted in S47 of FIG. 6. When the acquired document data is compressed document data (S83: Yes), the CPU 47 decompresses the compressed document data (S85). As described above, a known compression technology is adopted to compress document data. Accordingly, a known decompression technology is adopted to decompress document data. In S85, a program for compression and decompression processes stored in the storage 48 is executed. The other descriptions relating to decompression of document data are omitted. The decompressed document data is stored in the RAM 49.

When the acquired document data is not compressed document data (S83: No) or after executing S85, the CPU 47 transmits a completion notification (S87). The completion notification includes the terminal ID of the terminal apparatus itself and the document ID included in the acquired document data. The CPU 47 outputs a transmission command of the completion notification to the communicator 53. In accordance with the transmission command, the completion notification is transmitted from the communicator 53 to the server apparatus 20. Further, the completion notification is transmitted from the server apparatus 20 to the terminal apparatus 42 or the terminal apparatus 43 that is the transmission source of the document data. Assume that the compressed document data is one compression file obtained by putting a plurality of document data together, and that the plurality of document data has been acquired by the process of S85. In this case, the completion notification transmitted in S87 includes a plurality of document IDs included in respective ones of the acquired plurality of document data. Alternatively, a completion notification may be generated for each of the plurality of document data, and each completion notification may include one document ID.

After executing S87, the CPU 47 displays waiting information 71 (S89). The waiting information 71 is information for notifying that the terminal apparatus 41 is waiting to display the document image 72. The CPU 47 outputs, to the display 50, an output command of displaying the waiting information 71 on the teleconference screen 60. In accordance with the output command, the display 50 displays the waiting information 71 on the teleconference screen 60 (see the upper part of FIG. 12). After executing S89, the CPU 47 returns the process to S81. After that, the CPU 47 repeatedly executes the processes in S81 and thereafter.

In S91, the CPU 47 determines whether a display instruction is acquired. The display instruction is transmitted in S21 of FIG. 4 or in S77 of FIG. 10, and is received at the communicator 53. The CPU 47 acquires the display instruction through the communicator 53. When the display instruction is acquired (S91: Yes), the CPU 47 displays the document image 72 (S93). The display instruction includes a document ID. The document image 72 to be displayed is the document image corresponding to document data of this document ID. The CPU 47 outputs, to the display 50, an output command of displaying the above-mentioned document image 72 on the teleconference screen 60. On the display 50, in accordance with the output command, the waiting information 71 that is being displayed on the teleconference screen 60 is changed to the above-described document image 72 (see the lower part of FIG. 12). When no display instruction is acquired (S91: No) or after executing S93, the CPU 47 returns the process to S81. After that, the CPU 47 repeatedly executes the processes in S81 and thereafter. Similar to the instruction receiving process shown in FIG. 4, the receiving process is continued until an end instruction is acquired due to press of the end button 62.

<Effects of the Embodiment>

According to the embodiment, the following effects can be obtained. In the following descriptions, it is assumed that the terminal apparatus 41 is the terminal apparatus of the transmission source of document data, and that the terminal apparatuses 42, 43 are terminal apparatuses of the transmission destination of document data.

(1) In the terminal apparatus 41, the document specifying screen 66 is displayed (see S31 of FIG. 6), and an application is selected. Assume that, for example, the OK button 68 is pressed in a state where the icon images A, B are selected out of the icon images A, B, C included in the document specifying screen 66 (see FIG. 7). In this case, the CPU 47 acquires a share instruction specifying the applications A, B as the share target and, after that, acquires the document data A obtained by capturing the operating screen 70A including a particular document image 72 and the document data B obtained by capturing the operating screen 70B including another document image 72 (see S33 of FIG. 6). In the terminal apparatus 41, when a plurality of document data is acquired, the active document data is identified as the document data that is transmitted to the terminal apparatuses 42, 43 prior to other documents (see S51: Yes and S53 of FIG. 8). When there is no active document data (see S51: No of FIG. 8), the document data of the first rank is identified as the document data that is transmitted to the terminal apparatuses 42, 43 prior to other documents (see S55 of FIG. 8). For example, assume that the document data A is identified in S53 or S55 of FIG. 8, out of the document data A, B. In this case, first, the document data A is transmitted (see S39 of FIG. 6). After that, the document data B is compressed and is transmitted in a compressed state (see S45 and S47 of FIG. 6).

The terminal apparatuses 42, 43 sequentially receive document data that are transmitted from the terminal apparatus 41 in S39 and S47 of FIG. 6 (see S81: Yes of FIG. 11). The terminal apparatuses 42, 43 transmit a completion notification each time document data is received (see S87 of FIG. 11). For example, the completion notification transmitted when the document data A is received includes a document ID “IDA”. The completion notification transmitted when the document data B is received includes a document ID “IDB”. The terminal apparatus 41 receives each of the completion notification including the document ID “IDA” and the completion notification including the document ID “IDB” (see S61 and S63 of FIG. 9).

When the terminal apparatus 41 receives the completion notification including the document ID “IDA” from the terminal apparatuses 42, 43 (see S67: Yes of FIG. 9), the completion notification screen 63 is displayed (see S69 of FIG. 9). The image data corresponding to this completion notification screen 63 includes the document ID “IDA”. After that, when the display start button 64 in the completion notification screen 63 is pressed, a display instruction including the document ID “IDA” is transmitted to the terminal apparatuses 42, 43 (see S21 of FIG. 4). The terminal apparatuses 42, 43 display the document image 72 corresponding to the document data A of the document ID “IDA” (see S93 of FIG. 11).

When the terminal apparatus 41 receives completion notifications including the document ID “IDB” from the terminal apparatuses 42, 43 (see S67: Yes of FIG. 9), the completion notification screen 63 is displayed again (see S69 of FIG. 9). The image data corresponding to this completion notification screen 63 includes the document ID “IDB”. After that, when the display start button 64 in this completion notification screen 63 is pressed, a display instruction including the document ID “IDB” is transmitted to the terminal apparatuses 42, 43 (see S21 of FIG. 4). The terminal apparatuses 42, 43 display the document image 72 corresponding to the document data B of the document ID “IDB” (see S93 of FIG. 11).

Thus, each time transmitted document data is received by the terminal apparatuses 42, 43, such reception can be individually notified in the terminal apparatus 41. The terminal apparatus 41 can individually transmit a display instruction for the plurality of document images 72 in response to reception of each document data at the terminal apparatuses 42, 43. The timing of displaying each of the plurality of document images 72 at the terminal apparatuses 42, 43 can be individually set at the terminal apparatus 41. When a plurality of document data is transmitted, the document data to be transmitted prior to other document data can be appropriately determined based on the execution state of an application or the selection order. The user of the terminal apparatus 41 can start a presentation based on the document image 72 corresponding to document data transmitted prior to other document data, in a state where the other document data is not received by the terminal apparatuses 42, 43. By compressing document data that is not prioritized, the communication efficiency between the terminal apparatus 41 and the terminal apparatuses 42, 43 can be improved.

(2) Regarding a particular document data, it can be assumed that the timing at which the completion notification is transmitted from the terminal apparatus 43 is later than the timing at which the completion notification is transmitted from the terminal apparatus 42. For example, when the network environments of the terminal apparatuses 42, 43 are compared with each other, if the network environment of the terminal apparatus 43 is worse, such as a narrower bandwidth, a longer delay time, and/or a larger packet loss ratio, the above-mentioned status tends to occur. In the following descriptions, it is assumed that a completion notification has not been transmitted from the terminal apparatus 43 (see FIG. 5C). In the terminal apparatus 41, the timer 55 measures an elapse time that has elapsed after document data is transmitted (see S41 or S49 of FIGS. 6 and S71 of FIG. 10). When the time measured by the timer 55 is up (see S73 of FIG. 10) and a display instruction for the transmitted document data is untransmitted (see S75: Yes of FIG. 10), the terminal apparatus 41 transmits a display instruction to the terminal apparatus 42 having transmitted a completion notification, at the time when the time is up (see S77 of FIG. 10).

Thus, when a certain period has elapsed after document data is transmitted, a display instruction is transmitted automatically to the terminal apparatus 42 from which document data has been received. So, delay of start of the teleconference can be prevented. When a display instruction is transmitted automatically to the terminal apparatus 42 in S77 of FIG. 10, information indicative of that transmission may be displayed on the teleconference screen 60. Due to this information, the user of the terminal apparatus 41 can recognize that a display instruction has been transmitted and can start a teleconference. When the completion notification from the terminal apparatus 43 is received at the communicator 53 (see S61 of FIG. 9), the processes in S63 and thereafter are executed sequentially, and a display instruction is transmitted to the terminal apparatuses 42, 43 (see S67: Yes and S69 of FIG. 9). In the terminal apparatus 42, because the same display instruction has been received, S93 of FIG. 11 is not executed.

<Modifications>

While the disclosure has been described in detail with reference to the above aspects thereof, it would be apparent to those skilled in the art that various changes and modifications may be made therein without departing from the scope of the claims. Further, some configurations of modifications described below can be appropriately adopted in combination. In the following description, like parts and components are designated by the same reference numerals to avoid duplicating description.

(1) The server apparatus 20 is provided in the teleconference system 10 (see FIG. 1). For example, the document data, the completion notification, and the display instruction are transmitted and received among the terminal apparatuses 41, 42, and 43 through the server apparatus 20. The terminal apparatuses 41, 42, and 43 may perform direct communication through the network 90 to conduct a teleconference. In the teleconference system 10 in which such P2P teleconferences are conducted, the server apparatus 20 is omitted.

(2) The document data is image data obtained by capturing the operating screen 70 of the application that is running on the terminal apparatus participating in a teleconference. The document data may be preliminarily created by a particular application and may be, for example, data of a file type stored in the storage 48. In this case, an icon image of data of a particular file type stored in the storage 48 is displayed in the document specifying screen 66 that is displayed in S31 of the document transmitting process shown in FIG. 6, in a similar manner to FIG. 7. The user operates the operating interface 51 to select at least one of the displayed icon images. In S51 of the priority-document determining process shown in FIG. 8, it is determined whether there is document data that is processed in an application in an active state, out of document data that is acquired in S33 of FIG. 6 in response to display of the document specifying screen 66 in S31 of FIG. 6. When there is document data corresponding to the above-described condition (see S51: Yes of FIG. 8), that document data is identified (see S53 of FIG. 8). When there is no document data corresponding to the above-described condition (see S51: No of FIG. 8), the document data of the first rank is identified in a similar manner to the above (see S55 of FIG. 8).

Further, document data may be data stored in a file server apparatus connected to the network 90 and different from the server apparatus 20. It is assumed that the terminal apparatus 41 is the terminal apparatus of the transmission source of document data, and that the terminal apparatuses 42, 43 are the terminal apparatuses of the transmission destination of the document data. In this case, in S39 or S47 of FIG. 6 that is executed by the terminal apparatus 41, as document data, data including the URL of the location of data stored in the above-mentioned file server apparatus is transmitted from the communicator 53 to the server apparatus 20. The server apparatus 20 downloads particular data from the file server apparatus, in accordance with this URL. After that, the server apparatus 20 transmits the downloaded data to the terminal apparatuses 42, 43. Or, the server apparatus 20 may transmit the URL to the terminal apparatuses 42, 43. In this case, the terminal apparatuses 42, 43 download the particular data from the file server apparatus in accordance with the URL. The server apparatus 20 may transmit the downloaded data to the terminal apparatus 41. The terminal apparatus 41 displays the document image 72 corresponding to data sent from the server apparatus 20 on the teleconference screen 60 in a manner shown in the lower part of FIG. 12. That is, the document data is not limited to substantial data for displaying the document image 72 (for example, image data or file type data), but also includes link information to substantial data (URL and so on) as long as the document data is data for displaying the document image 72. In a case where the document data is link information to substantial data, in the receiving process shown in FIG. 11, when acquisition of substantial data indicated by link information is completed, positive determination is made in S81 (see S81: Yes of FIG. 11).

(3) The display instruction transmitted in S21 of the instruction receiving process shown in FIG. 4 may include the terminal IDs “USER42” and “USER43” of the terminal apparatuses 42, 43 that are the transmission destination, in a similar manner to S73 of FIG. 10. The server apparatus 20 determines, as the transfer destination of the display instruction, the terminal apparatus of the terminal ID included in the display instruction as the transmission destination. When the display instruction includes no terminal ID of the terminal apparatus of the transmission destination at all, the server apparatus 20 may determine, as the transmission destination of the display instruction, all the terminal apparatuses 42, 43 excluding the terminal apparatus 41 that is the transmission source of the display instruction.

(4) In the completion-notification receiving process shown in FIG. 9, when completion notifications have been acquired from all the terminal apparatuses that are counterparts of a teleconference (see S67: Yes of FIG. 9), the completion notification screen 63 is displayed in S69 (see FIG. 2). When positive determination is made in S67 (see S67: Yes of FIG. 9), for example, completion information illustrated in the completion notification screen 63 of FIG. 2 may be outputted from the speaker 52. For example, assume that completion notifications from the terminal apparatuses 42, 43 including the document ID “IDA” have been acquired. In this case, the speaker 52 may output a message “Document data A has been received by all the terminal apparatuses. Press the return key of the operating interface 51 to transmit a display instruction.”, for example. A document ID is added to audio data corresponding to this message when the audio data is created, in a similar manner to image data corresponding to the completion notification screen 63. In this case, the return key of the operating interface 51 is associated with the display instruction. In the instruction receiving process of FIG. 4, in response to press of the return key, positive determination is made in S19 (see S19: Yes of FIG. 4), subsequently, S21 is executed as described above. The part of the operating interface 51 associated with the display instruction may be a different key from the return key.

The completion notification receiving process may be started at the timing when S39 of FIG. 6 is executed and at the timing when S47 of FIG. 6 is executed. In this case, the process of each completion notification receiving process that is started at the timing when S39 or S47 is executed is managed in association with the document ID of the document data transmitted in S39 or S47, as in the timer process described above. When the completion notification has been received, the terminal apparatus of the transmission source of document data identifies the document ID included in the completion notification, and sequentially executes each process of S61 to S69 of FIG. 9 in the process of the completion notification receiving process associated with the identified document ID. Here, in the process corresponding to S61 of FIG. 9, until a process itself becomes the execution target for the completion notification including the associated document ID, that process is in a waiting state.

(5) A teleconference method in the teleconference system 10 conducted based on each process described above (see FIGS. 4, 6, and 8 to 11) may be conducted as described below. In the following descriptions, it is assumed that the terminal apparatus 41 is the terminal apparatus of the transmission source of document data, and that the terminal apparatuses 42, 43 are terminal apparatuses of the transmission destination of document data. The terminal apparatus 41 executes the instruction receiving process shown in FIG. 4 as described above, and in S17 executes the document transmitting process shown in FIG. 6 as described above. In the document transmitting process executed by the terminal apparatus 41, document data is transmitted to the server apparatus 20 in S39 or S47 of FIG. 6, and the server apparatus 20 transmits, to the terminal apparatuses 42, 43, the document data sent from the terminal apparatus 41. The server apparatus 20 stores the terminal IDs “USER42” and “USER43” of the terminal apparatuses 42, 43 that are the transmission destination of document data and the document ID of this document data in association with each other.

The terminal apparatuses 42, 43 executes the receiving process shown in FIG. 11 as described above, and transmits the completion notification to the server apparatus 20 in S87. The server apparatus 20 receives (acquires), from the terminal apparatus 42, the completion notification including the document ID of the document data and the terminal ID “USER42” stored in association with this document ID when the document data is transmitted. And, the server apparatus 20 receives, from the terminal apparatus 43, the completion notification including the above-mentioned document ID and the terminal ID “USER43” stored in association with this document ID. At this time, the server apparatus 20 transmits display instructions to the terminal apparatuses 42, 43 and transmits a completion notification to the terminal apparatus 41. The terminal apparatuses 42, 43 receive the display instruction transmitted from the server apparatus 20 (see S91: Yes of FIG. 11). The terminal apparatus 41 starts the completion-notification receiving process shown in FIG. 9 as described above, and executes S61. The terminal apparatus 41 receives the completion notification from the server apparatus 20 at the communicator 53 (see S63 of FIG. 9). In the completion-notification receiving process here, S65 and S67 of FIG. 9 are omitted and, after executing S63, S69 is executed as described above. By executing S69, the completion notification screen is displayed on the teleconference screen displayed on the display 50, in a manner similar to the above. However, the display start button 64 is omitted in the completion notification screen. This is because the display instruction is transmitted from the server apparatus 20, as described above. That is, the instruction receiving process shown in FIGS. 4, S19 and S21 are omitted. When negative determination is made in S15 (S15: No in FIG. 4), the process returns to S13. On condition that a completion notification screen including no display start button 64 is displayed on the teleconference screen, the user of the terminal apparatus 41 can start a presentation based on the document image 72 in a manner similar to the above.

Further, a teleconference method by the teleconference system 10 may be conducted as described below. That is, after transmission of document data from the terminal apparatus 41 to the terminal apparatus 42 is started and transmission of the document data to the terminal apparatus 42 is completed, the server apparatus 20 stores the terminal ID “USER42” of the terminal apparatus 42 and the document ID of the document data of the transmission target in association with each other. Subsequently, after transmission of the document data to the terminal apparatus 43 is started and transmission of the document data to the terminal apparatus 43 is completed, the server apparatus 20 stores the terminal ID “USER43” of the terminal apparatus 43 and the document ID of the document data of the transmission target in association with each other. In the terminal apparatuses 42, 43, the receiving process shown in FIG. 11 is executed as described above. However, in the receiving process here, S87 is omitted. When the server apparatus 20 stores the terminal IDs of all the terminal apparatuses 42, 43 that are the transmission destination of document data for the document ID of the document data of the transmission target, the server apparatus 20 determines that the document data has been received (acquired) by the terminal apparatuses 42, 43 and transmits display instructions to the terminal apparatuses 42, 43. At this time, the server apparatus 20 may transmit a completion notification to the terminal apparatus 41. The terminal apparatus 41 starts the completion-notification receiving process shown in FIG. 9 as described above, executes S61, and receives the completion notification from the server apparatus 20 at the communicator 53 (see S63 of FIG. 9). In the completion-notification receiving process here, too, S65 and S67 of FIG. 9 are omitted and, after executing S63, S69 is executed as described above. By executing S69, the completion notification screen is displayed on the teleconference screen displayed on the display 50, in a manner similar to the above. However, the display start button 64 is omitted in the completion notification screen due to the reason similar to the above.

When adopting one of the above-described two procedures, the server apparatus 20 may start a process similar to the timer process shown in FIG. 10 in response to transmission of document data to the terminal apparatuses 42, 43. According to this, even if a completion notification is not received from both of the terminal apparatuses 42, 43, a display instruction is transmitted to the terminal apparatus from which a completion notification has been received. When the display instruction is transmitted, the server apparatus 20 transmits a completion notification to the terminal apparatus 41. When adopting one of the above-described procedures, S41 and S49 are omitted in the document transmitting process shown in FIG. 6, and the timer process shown in FIG. 10 is also omitted. Further, the document database shown in FIGS. 5A to 5E is a database in which document IDs are stored. The document database may be omitted.

Further, a teleconference method by the teleconference system 10 may be conducted as described below. That is, the server apparatus 20 transmits document data sent from the terminal apparatus 41 to the terminal apparatus 42 and subsequently transmit the document data to the terminal apparatus 43 in a manner similar to the above, and transmits a completion notification to the terminal apparatus 41 in a state where the terminal IDs “USER42” and “USER43” of the terminal apparatuses 42, 43 and the document ID of the document data of the transmission target are stored in association with each other. The terminal apparatus 41 starts the completion-notification receiving process shown in FIG. 9 as described above, executes S61, and receives the completion notification from the server apparatus 20 at the communicator 53 (see S63 of FIG. 9). In the completion-notification receiving process here, too, S65 and S67 of FIG. 9 are omitted and, after executing S63, S69 is executed as described above. By executing S69, the completion notification screen 63 is displayed on the teleconference screen 60 displayed on the display 50, in a manner similar to the above. After that, the terminal apparatus 41 appropriately executes S19 and S21 of FIG. 4, and transmits a display instruction. However, the display instruction may be transmitted in S77 of the timer process shown in FIG. 10, in a manner similar to the above. In the document database shown in FIGS. 5A to 5E, storing of the “terminal from which completion notification has been acquired” may be omitted.

Instead of the terminal apparatus 41, the server apparatus 20 may compress document data. That is, in the document transmitting process shown in FIG. 6, when there is untransmitted document data (see S43: Yes of FIG. 6), in S47 the terminal apparatus 41 may transmit uncompressed document data to the server apparatus 20, without executing S45. In this case, after receiving uncompressed document data transmitted from the terminal apparatus 41 in S47, the server apparatus 20 compresses the received document data by a known compression technology in a similar manner to S45 of FIG. 6. The server apparatus 20 transmits the compressed document data to the terminal apparatuses 42, 43.

What is claimed is:

1. A non-transitory computer-readable storage medium storing a program executable by a computer that controls a first terminal apparatus configured to participate in a teleconference through a network, the program causing, when executed, the first terminal apparatus to perform operations comprising:
a first transmitting operation of transmitting document data to a second terminal apparatus participating in the teleconference through a first communicator of the first terminal apparatus connected to the network, the document data corresponding to a document image to be shared with the second terminal apparatus in the teleconference;
a first acquiring operation of acquiring, through the first communicator, a completion notification indicating that the document data is acquired at transmission destination of the document data, the transmission destination including the second terminal apparatus; and
a second transmitting operation of, in response to acquiring the completion notification, transmitting a display instruction to the second terminal apparatus through the first communicator, the display instruction being an instruction to display the document image corresponding to the document data on a display of the second terminal apparatus.

2. The storage medium according to claim 1, wherein the program causes, when executed, the first terminal apparatus to perform operations further comprising:
a notifying operation of, in response to acquiring the completion notification, outputting completion information to a notifier of the first terminal apparatus, the completion information indicating that the completion notification is acquired; and
a second acquiring operation of, in response to output of the completion information from the notifier, acquiring an operation inputted through an operating interface of the first terminal apparatus, the operation being for outputting the display instruction; and
wherein the second transmitting operation comprises, in response to acquiring the operation, transmitting the display instruction to the second terminal apparatus through the first communicator.

3. The storage medium according to claim 1, wherein the program causes, when executed, the first terminal apparatus to perform operations further comprising:
a third acquiring operation of acquiring a share instruction of specifying a plurality of document data as the document data; and
a determining operation of determining first document data that is transmitted first in the plurality of document data;
wherein the first transmitting operation comprises:
transmitting the first document data to the second terminal apparatus through the first communicator; and
transmitting at least one second document data to the second terminal apparatus through the first communicator in a state where the transmission of the first document data has started, the at least one second document data being document data excluding the first document data from the plurality of document data specified by the share instruction.

4. The storage medium according to claim 3, wherein the determining operation comprises determining, as the first document data, the document data corresponding to a document image in an operating screen in an active state that is displayed on a display of the first terminal apparatus.

5. The storage medium according to claim 3, wherein the determining operation comprises:
determining whether active document data exists, the active document data corresponding to a document image in an operating screen in an active state that is displayed on a display of the first terminal apparatus;
in response to determining that the active document data exists, determining the active document data as the first document data; and
in response to determining that the active document data does not exist, determining document data of a first rank as the first document data, the document data of the first rank being document data corresponding to an indicator that is specified first in a plurality of indicators in a document specifying screen displayed on the display.

6. The storage medium according to claim 5, wherein the indicator is an icon image.

7. The storage medium according to claim 3, wherein the program causes, when executed, the first terminal apparatus to perform operations further comprising:
a compressing operation of compressing the at least one second document data; and
wherein the first transmitting operation comprises transmitting the at least one second document data compressed by the compressing operation to the second terminal apparatus through the first communicator in a state where the transmission of the first document data has started, the first document data being uncompressed.

8. The storage medium according to claim 1, wherein the first transmitting operation comprises transmitting the document data through the first communicator to a third terminal apparatus participating in the teleconference; and
wherein the second transmitting operation comprises, in response to acquiring the completion notification from both the second terminal apparatus and the third terminal apparatus, transmitting the display instruction to the second terminal apparatus and the third terminal apparatus through the first communicator, the second terminal apparatus and the third terminal apparatus being the transmission destination of the document data.

9. The storage medium according to claim 8, wherein the second transmitting operation comprises, in response to acquiring the completion notification from the second terminal apparatus without acquiring the completion notification from the third terminal apparatus in a state where a predetermined time elapses after the transmission of the document data to the second terminal apparatus and the third terminal apparatus has started, transmitting the display instruction to the second terminal apparatus through the first communicator without transmitting the display instruction to the third terminal apparatus through the first communicator.

10. A non-transitory computer-readable storage medium storing a program executable by a computer that controls a second terminal apparatus configured to participate in a teleconference through a network, the program causing, when executed, the second terminal apparatus to perform operations comprising:
a fourth acquiring operation of acquiring document data through a second communicator of the second terminal apparatus connected to the network, the document data corresponding to a document image to be shared with a first terminal apparatus in the teleconference, the document image being specified by the first terminal apparatus participating in the teleconference;
a third transmitting operation of, in response to acquiring the document data, transmitting, through the second communicator, a completion notification indicating that the document data is acquired;
a fifth acquiring operation of acquiring, through the second communicator, a display instruction instructing displaying of the document data; and
a displaying operation of, in response to acquiring the display instruction, displaying a document image corresponding to the document data on a display of the second terminal apparatus.

11. The storage medium according to claim 10, wherein the program causes, when executed, the second terminal apparatus to perform operations further comprising:
a decompressing operation of, when the document data acquired by the fourth acquiring operation is compressed, decompressing the compressed document data; and
wherein the third transmitting operation comprises transmitting the completion notification through the second communicator in a state where decompression of the compressed document data is completed.

12. A teleconference method conducted by a teleconference system including a first terminal apparatus and a second terminal apparatus participating in a teleconference through a network, the method comprising:
transmitting document data through a first communicator of the first terminal apparatus connected to the network, the document data corresponding to a document image to be shared with the second terminal apparatus in the teleconference;
acquiring the document data transmitted from the first terminal apparatus, through a second communicator of the second terminal apparatus connected to the network;
determining whether acquisition of the document data by the second terminal apparatus is completed;
transmitting, in response to determining that acquisition of the document data by the second terminal apparatus is completed, a display instruction to the second terminal apparatus, the display instruction being an instruction to display a document image corresponding to the document data;
acquiring the display instruction through the second communicator; and
displaying, in response to acquiring the display instruction, the document image corresponding to the document data on a display of the second terminal apparatus.
